(19) United States
(12) Patent Application Publication
(10) Pub. No.: US 2024/0347038 A1
(43) Pub. Date: Oct. 17, 2024

(54) OUTPUT VOICE TRACK GENERATION

(71) Applicant: GAN STUDIO INC, Perrysburg, OH (US)

(72) Inventor: Suvrat BHOOSHAN, New Delhi (IN)

(21) Appl. No.: 18/689,696

(22) PCT Filed: Aug. 31, 2022
(86) PCT No.: PCT/IN2022/050776

§ 371 Date: Mar. 6, 2024

(30) Foreign Application Priority Data
Sep. 7, 2021 (IN) 202111040601

(51) Int. Cl. G10L 13/06; G10L 13/033; G10L 13/047; G10L 13/10; G10L 15/02; G10L 15/06; G10L 15/08; G10L 25/21; G10L 25/90

(52) U.S. Cl. CPC G10L 13/06; G10L 13/0335; G10L 13/047; G10L 13/10; G10L 15/02; G10L 15/063; G10L 15/08; G10L 25/21; G10L 25/90; G10L 2013/105; G10L 2015/025; G10L 2015/0635

(57) ABSTRACT

Approaches for generating an output voice track corresponding to an input text data using a voice generation system are described. In an example, by the voice generation system, a reference voice sample and the input text data is obtained. In an example, form the reference voice sample, a voice characteristic information and corresponding attribute values are extracted. The voice characteristic information may thus be processed based on a voice generation model. The voice generation model is to assign a weight for each of the voice characteristics based on their attribute values. Once a weighted voice characteristic information is generated, an output voice track corresponding to the input text data is generated.

### BACKGROUND

The internet has increased the outreach of multimedia content, such as video and audio. Despite the content being available ubiquitously, it may still not be consumed if the language of content is other than what an intended viewer is capable of understanding. Generating content in different languages may therefore require conversion of an audio recording of a video content or an audio content (such as an audiobook) into different languages. To this end, voice over or dubbing artists trained in different languages may be used for creating a separate audio recording which may then replace the original audio recording of said content. For example, to dub a video with English voices into Japanese, a voice actors proficient in Japanese may be utilized for creating the new updated audio recording or an audiotrack. The audiotrack may be based on a script in a desired language.

### BRIEF DESCRIPTION OF FIGURES

Systems and/or methods, in accordance with examples of the present subject matter are now described and with reference to the accompanying figures, in which:

FIG. 1 illustrates a computing system for generating an output voice track corresponding to an input text data, as per an example;

FIG. 2 illustrates a computing system for training a voice generation model, as per another example;

FIG. 3 illustrates a computing system for generating an output voice track corresponding to an input text data, as per an example;

FIG. 4 illustrates a method for training a voice generation model, as per an example; and

FIG. 5 illustrates a method for training a voice generation model and generating an output voice track corresponding to an input text data, based on a trained system classification model, as per an example;

### DETAILED DESCRIPTION

Advent of digital media content, such as video or audio, and digital technology facilitated the content developers, such as filmmakers, to reach out to the people living in different geographical terrain across the globe. Such geographically displaced people may speak different languages based on their cultural and religious environment. For example, in India, there are many regional languages. Media content may be initially created having an audiotrack based on a single language. Thereafter, such content may be dubbed or voiced over, wherein by doing so the original audiotrack may be replaced with a dubbing audiotrack during post-production having audio in a different language. To this end, the voice actors may read from a printed script based on which the dubbing audiotrack may be created.

To reduce costs and time inefficiencies, the content may be developed in either a single or few selected languages. As a result, the reach of the content may be only limited to the region where such languages are commonly spoken. For example, a video in English dubbed in Spanish may be relevant and perhaps targeted for viewers who speak or understand Spanish. In case the content needs to be distributed in other regions where other languages are predominant, the video may be dubbed again to provide the content in the targeted language. Such a process has to be planned in advance, which involves higher cost and is time consuming as well.

Certain Text to Speech (TTS) voice over systems are also present which converts text scripts or data into corresponding audio voice based on the character level segmentation of the text data. In most of the instances, such TTS converters manages to generate audio in any language. Such converters provide very coarse control on the rhythm and pitch. However, such mechanisms fail to capture either the tone or the voice modulation of the original audiotrack, which may be generally more attributable to an audio track generated based on a voice actor's input.

Approaches for generating an output voice track are described. In an example, the generation of the output voice track is based on an input text data and voice characteristic information of a reference voice sample. The input text data may be a text data or a script which is to be converted into corresponding output voice track. In one example, the voice characteristic information based on which the input text data is to be converted is extracted from the reference voice sample. The voice characteristic information may also include attribute values corresponding to the plurality of voice characteristics of the reference voice sample. Examples of plurality of voice characteristics include, but may not be limited to, number of phonemes, types of phonemes present in the reference voice sample, duration of each phoneme, pitch of each phoneme, and energy of each phoneme. In one example, pitch and energy values of each phonemes are being extracted or calculated based on a proxy metrics for approximating pitch and energy at a phoneme level. The reference voice sample may be attributable to persons speaking different languages and having different vocal characteristics. It may be noted that the term voice track would refer to any audio track or a sound recording corresponding to spoken content in an audio or video content which may either played back as standalone content (e.g., in the case of audiobook) or may correspond to specific video content (in the case of voice recording for video content).

Returning to the present subject matter, once extracted the voice characteristic information may be processed based on a voice generation model. The voice generation model may be used to categorize each voice characteristic of the reference voice sample as one of a plurality of voice characteristic. Based on the categorization of the voice characteristic, a corresponding weight may be assigned for each voice characteristic based on their corresponding attribute value and the same is stored as a weighted voice characteristic information. For example, based on type of phonemes present in the input voice, a weight ranging from 1 to m is assigned (m is the number of phonemes present in specific language) for each phoneme. Similarly, corresponding weight for duration (in milli second), pitch (from −∞ to +∞), and energy (from −∞ to +∞) are assigned for each phoneme. Once the weight is assigned, an output voice track corresponding to the input text data is generated based on the weighted voice characteristic information. For example, if reference voice sample is in English language and on processing it is determined that it includes 3 phonemes (each is different) with certain duration, pitch and energy, the output voice track may be accordingly generated based on the voice characteristic information. In one example, the input text data and the reference voice sample may correspond to different languages. For example, the input text data is in English and the reference voice sample is in Spanish. In such a case, the voice characteristics information of the Spanish reference voice sample is used to generate an English output voice track.

In an example, the voice generation model may be a machine learning model, a neural network-based model or a deep learning model which is trained based on a training voice sample and a corresponding training text data. In one example, a training voice characteristic information is extracted from the training voice sample for training the voice generation model. The training voice characteristics information further includes attribute values corresponding to each voice characteristics. Examples of voice characteristics include, but may not be limited to, types of phonemes present in the training voice sample, number of phonemes, duration of each phoneme, pitch of each phoneme, and energy of each phoneme. Such training voice sample and training text data correspond to different languages. In one example, pitch and energy values of each phonemes are being extracted or calculated based on a proxy metrics for approximating pitch and energy at a phoneme level.

The training voice characteristic information of the training voice sample is associated with a corresponding training text data. The training text data represents a text data which is to be converted into output voice track based on the training voice characteristic information. The training text data may be considered as any text script written in any language and the corresponding training voice sample may be considered as a voice sample, which is generated, when the text data is converted into output voice track. In one example, one or more training voice samples may be associated with single training text data.

The present approaches provide an opportunity for the user to change output voice track based on the voice characteristic information of its choice having certain set of characteristics. On ascertaining that the automatically generated output voice track is not as per the required vocal standard or lack vocational characteristics, user provides reference voice sample to provide information regarding required voice characteristics. Owing to the presence of reference voice sample, the voice generation system utilizes the reference voice sample to generate the output voice track based on the voice characteristics information once extracted from the reference voice sample.

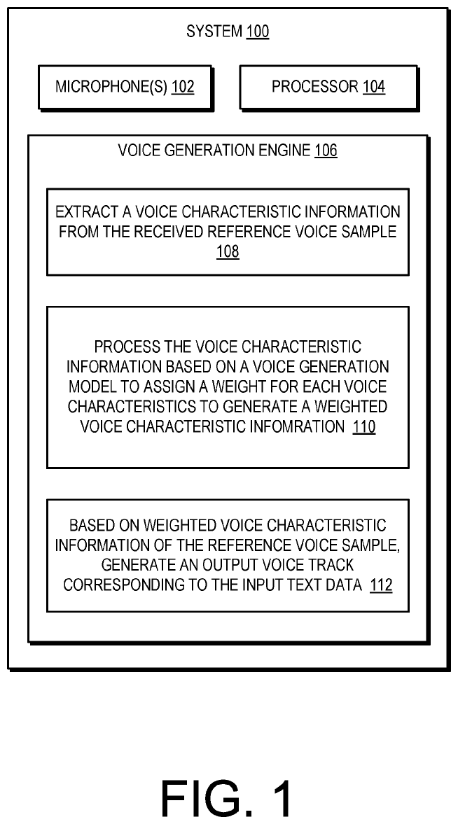

The manner in which the example computing systems are implemented are explained in detail with respect to FIGS. 1-5. While aspects of described computing system may be implemented in any number of different electronic devices, environments, and/or implementations, the examples are described in the context of the following example device(s). It may be noted that drawings of the present subject matter shown here are for illustrative purpose and are not to be construed as limiting the scope of the claimed subject matter.

FIG. 1 illustrates an example computing system 100 for converting text data into corresponding output voice track. The conversion of text data into output voice track is based on a voice characteristic information of a reference voice sample, in accordance with an example of the present subject matter. Examples of system 100 include, but are not limited to a portable computer, laptops, mobile phones, notebooks and other type of computing system. Although not depicted, the system 100 may include other components, such as interfaces to communicate over the network or with external storage or computing devices, display, input/output interfaces, operating systems, applications, data, and the like, which have not been described for brevity.

The system 100 may include a microphone(s) 102 and a processor 104. The microphone 102 may be used to receive a reference voice sample from a user. The microphone 102 may be implemented either as a single microphone or as an array of microphones. The microphone 102 may either be integrated within the system 100 or may be a part of an audio device, such as a wireless headset, which may be externally coupled to the system 100. It would be noted that any other type of microphone, which may be capable of receiving the reference voice sample from the user, may be coupled to the system 100, and may be used without deviating from the scope of the present subject matter. The processor 104 may be implemented as microprocessors, microcomputers, microcontrollers, digital signal processors, central processing units, state machines, logic circuitries, and/or any devices that manipulate signals based on operational instructions. Among other capabilities, the processor 104 is configured to fetch and execute computer-readable instructions stored in a memory (not shown) to converting the text data into output voice track based on the voice characteristic information of the reference voice sample.

The system 100 may further include a voice generation engine 106, which may be coupled to the processor 104, and microphone(s) 102. The voice generation engine 106, amongst other functions, may obtain the reference voice sample from the microphone(s) 102 for converting text data into output voice track based on the voice characteristic information extracted from the obtained reference voice sample.

During the course of operation of the system 100, if in case user is not satisfied with a predicted output voice track generated by the system 100, the microphone(s) 102 may be caused to receive a reference voice sample from a user The received reference voice sample is obtained by the voice generation engine 106 to extract a voice characteristic information from the reference voice sample. In an example, the voice generation engine 106 may extract the voice characteristic information from the received reference voice sample (represented as block 108). The voice characteristic information may further comprise an attribute value corresponding to plurality of voice characteristics of the reference voice sample.

After extracting the voice characteristic information from the reference voice sample, the voice generation engine 106 further processes the extracted voice characteristic information based on a voice generation model to assign a weight for each voice characteristics (represented as block 110). In an example, the weight for each voice characteristics is assigned based on the attribute values of the plurality of voice characteristics to determine a weighted voice characteristic information. In one example, the voice generation model is a neural network or a machine learning algorithm which may be trained based on a training voice characteristic information and a training text data. Based on weighted voice characteristic information, the voice generation engine 106 generate an output voice track corresponding to the input text data (represented as block 112). Thereafter, the voice generation engine 106 may generate control instructions based on which the generated output voice track is transmitted to a speaker.

As may be noted, the present approaches utilizes the voice characteristic information of the reference voice sample for converting the text data into corresponding output voice track. Using the voice characteristic information extracted from the reference voice sample increases the chance of generating the output voice track which is more attributable to the vocal characteristics of the person at phoneme level. In another example, the reference voice sample, and the text data may correspond to different language. For example, if user wants to generate the output voice track in English and does not know English language and speaks Urdu. Then, the voice generation system receives the reference voice sample in Urdu and uses its voice characteristics to convert the English text into output voice track having voice characteristics similar to that of the user. These and other examples are further described in detail in conjunction with the remaining figures.

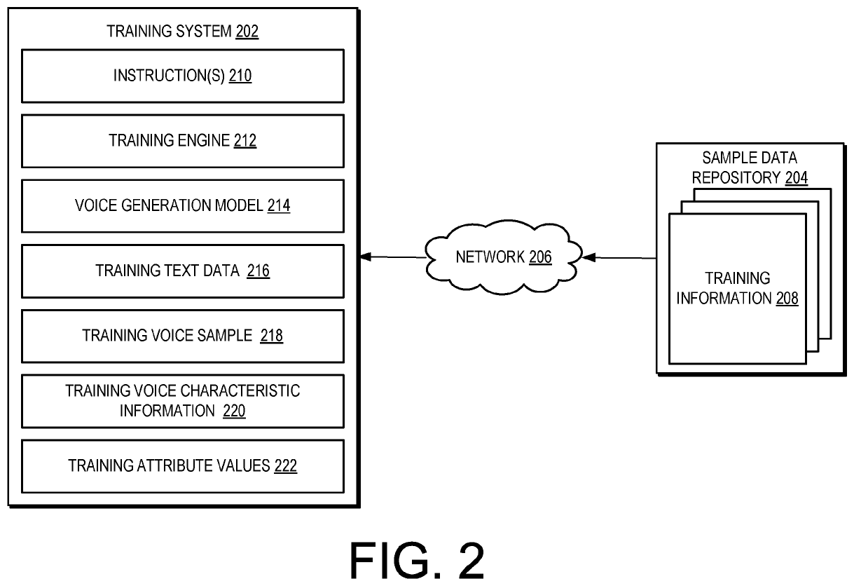

FIG. 2 illustrates a training system 202 comprising a processor or memory (not shown), for training a voice generation model. In an example, the training system 202 (referred to as system 202) may be communicatively coupled to a sample data repository 204 (referred to as repository 204) through a network 206. In another example, the repository 204 may reside inside the system 202 as well. The repository 204 may further include training information 208. In an example, the training information 208 may include a training text data 216 and a training voice sample 218. In one example, there exist one or more training voice sample 218 of different languages for a single training text data 216. As also described in conjunction with FIG. 1, the training voice sample may include voice characteristic information which in turn includes attribute values of plurality of voice characteristics of the training voice sample. In an example, the plurality of voice characteristics may be a type of phonemes present in the voice sample, number of phonemes, duration of each phoneme, pitch of each phoneme, energy of each phoneme, and combination thereof. The training information 208, although depicted as being obtained from a single repository, such as repository 204, may also be obtained from multiple other sources without deviating from the scope of the present subject matter. In such cases, each of such multiple repositories may be interconnected through a network, such as the network 206.

The network 206 may be a private network or a public network and may be implemented as a wired network, a wireless network, or a combination of a wired and wireless network. The network 206 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system 202 may further include instructions 210 and a training engine 212. In an example, the instructions 210 are fetched from a memory and executed by a processor included within the system 202. The training engine 212 may be implemented as a combination of hardware and programming, for example, programmable instructions to implement a variety of functionalities. In examples described herein, such combinations of hardware and programming may be implemented in several different ways. For example, the programming for the training engine 212 may be executable instructions, such as instructions 210. Such instructions may be stored on a non-transitory machine-readable storage medium which may be coupled either directly with the system 202 or indirectly (for example, through networked means). In an example, the training engine 212 may include a processing resource, for example, either a single processor or a combination of multiple processors, to execute such instructions. In the present examples, the non-transitory machine-readable storage medium may store instructions, such as instructions 210, that when executed by the processing resource, implement training engine 212. In other examples, the training engine 212 may be implemented as electronic circuitry.

The instructions 210 when executed by the processing resource, cause the training engine 212 to train a voice generation model, such as a voice generation model 214. The instructions 210 may be executed by the processing resource for training the voice generation model 214 based on the training information 208. The system 202 may further include a training text data 216, a training voice sample 218, a training voice characteristic information 220, and a training attribute values 222. In an example, the system 202 may obtain single training information 208 at one time from the repository 204, and the information pertaining to that is stored as training text data 216 and training voice sample 218. Thereafter, the training voice sample 218 is further processed to extract the training voice characteristic information and is stored as training voice characteristic information 220.

In one example, the training voice characteristic information 220 may further include training attribute values 222. For training, the attribute values, such as training attribute values 222, of the training voice characteristic information 220 may be used to train the voice generation model 214. The voice generation model 214 may then be used to assign a weight for each of the plurality of voice characteristics. Example of voice characteristics include, but may not be limited to, number of phonemes, type of phonemes present in the voice sample, duration of each phoneme, pitch of each phoneme, and energy of each phoneme. The attribute values, such as training attribute values 222, corresponding to the voice characteristics of the training voice sample 218 may include numeric or alphanumeric values representing the level or quantity of each voice characteristic. For example, English language has total of 44 phonemes and each phoneme is represented by a certain value. Each of the phoneme has certain duration, pitch and energy which may also be represented numerically and alphanumerically. In one example, the training voice characteristic information 220 with corresponding training attribute values 222 are stored in the form of a data structure. It may be noted that, above disclosed training attribute values 222 is exemplary, it may take distinct information based on the type of the voice characteristics of the training voice sample.

The attribute values, such as training attribute values 222, once extracted from the training voice characteristic information 220 may be categorized in groups based on language they belong. For example, the training attribute values 222 corresponding to the English language may be grouped under one category. Similarly training attribute values corresponding to other languages may be grouped under their respective languages.

In operation, the system 202 obtain the training information 208 from the repository 204 which may be further processed to extract the training voice characteristic information 220. Once the training voice characteristic information 220 is extracted, the training attribute values 222 corresponding to each voice characteristics are derived or extracted. Based on the extracted attribute values, such as training attribute values 222, the training engine 212 may trains the voice generation model 214. Once trained, the voice generation model 214 may be implemented as an ordered data structure or a look up table. Such look up table or ordered data structure include plurality of entries, with top level entry represents different languages and under each language entry corresponding voice characteristics with respective attribute value and weights are stored.

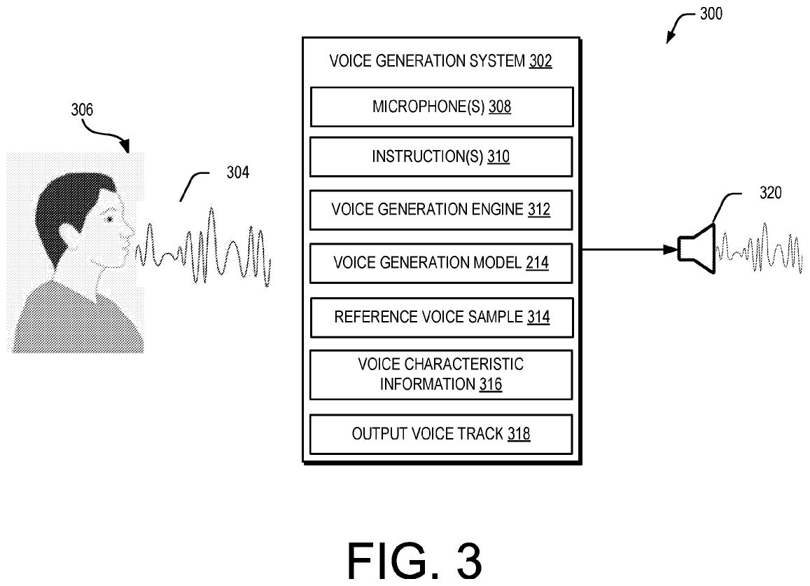

Once the voice generation model 214 is trained, it may be utilized for assigning a weight for each of the plurality of voice characteristics. For example, a voice characteristic information pertaining to a reference voice sample may be processed based on the voice generation model 214. In such a case, based on the voice generation model 214, the voice characteristic information of the reference voice sample is weighted based on their corresponding attribute values. Once the weight of each of the voice characteristic is determined, the voice generation model 214 utilizes the same and generate an output voice track corresponding to an input text data. The manner in which the weight for each voice characteristics of reference voice sample is assigned by the voice generation model 214 is further described in conjunction with FIG. 3.

FIG. 3 illustrates a communication environment 300 comprising a voice generation system 302 (referred to as system 302), for converting text data into corresponding voice output based on voice characteristic information of a reference voice sample 304 received via microphone(s) 308 from a user 306. In an example, the system 302 may assign a weight for each of the plurality of voice characteristics of the reference voice sample 304 based on a trained voice generation model, such as voice generation model 214. The reference voice sample 304 from the user 306 may be the ideal voice sample having ideal voice characteristic information which may the user 306 want to be used by the system 302 to convert text data into voice output. In one example, the reference voice sample 304 may be of a different language as compared to the language of the text data. For example, reference voice sample 304 is in Spanish and the input text data is in English.

Similar to the system 102 or 202, the system 302 may further include instructions 310 and a voice generation engine 312. In an example, the instructions 310 are fetched from a memory and executed by a processor included within the system 302. The voice generation engine 312 may be implemented as a combination of hardware and programming, for example, programmable instructions to implement a variety of functionalities. In examples described herein, such combinations of hardware and programming may be implemented in several different ways. For example, the programming for the voice generation engine 312 may be executable instructions, such as instructions 310. Such instructions may be stored on a non-transitory machine-readable storage medium which may be coupled either directly with the system 302 or indirectly (for example, through networked means). In an example, the voice generation engine 312 may include a processing resource, for example, either a single processor or a combination of multiple processors, to execute such instructions. In the present examples, the non-transitory machine-readable storage medium may store instructions, such as instructions 310, that when executed by the processing resource, implement voice generation engine 312. In other examples, the voice generation engine 312 may be implemented as electronic circuitry.

The system 302 may include a voice generation model, such as the voice generation model 214. The system 302 may further include an input text data (not shown in FIG. 3), reference voice sample 314, a voice characteristic information 316 and an output voice track 318. In an example, voice characteristic information 316 is extracted from the reference voice sample 314 which in turn further includes attribute values corresponding to the voice characteristics of the reference voice sample 314. The output voice track 318 is an output voice track which may be generated by converting text data into corresponding voice output based on the voice characteristic information 316 of the reference voice sample 314.

In operation, initially, the microphone(s) 308 of the system 302 may receive the reference voice sample 304 from the user 306 and store it as the reference voice sample 314 in the system 302. Thereafter, the voice generation engine 310 of the system 302 extracts a voice characteristic information, such as voice characteristic information 316, from the received reference voice sample 314. Example of voice characteristics includes, but may not be limited to, type of phonemes present in the reference voice sample, number of phonemes, duration of each phoneme, pitch of each phoneme, and energy of each phoneme. Amongst other things, the voice characteristic information 316 may further include attribute values of the different voice characteristics. For example, the attribute values of the voice characteristics may specify the number of phonemes present (numerically), type of phonemes (alphanumerically), pitch of each phoneme (from −∞ to +∞), duration (in milli second) and energy (from −∞ to +∞) of each phoneme. Such phoneme level segmentation of reference voice sample provides accurate vocal characteristics of a person for imitating.

Once the voice characteristic information 316 is extracted, the attribute values pertaining to the voice characteristics of the reference voice sample 314 are obtained or derived. Using the derived attribute values, the voice generation engine 312 may identify or categorize the type of the voice characteristics from the plurality of available voice characteristics. Once the type of voice characteristic is identified, the voice generation engine 312 may compare the derived attribute value with a value linked with a categorized weight of the identified type of voice characteristic. In an example, a reference voice sample, such as reference voice sample 304, having attribute values pertaining to the voice characteristics, such as 1 phoneme, /t/ phoneme, 0.1 milli sec duration etc. is compared with values stored in the voice generation model 214. On determining that the derived attribute value matches with the value linked with the categorized weight, the voice generation engine 312 assign the categorized weight as the weight for the obtained voice characteristics. Now, the same procedure is followed for each and every voice characteristic and a specific weight is assigned for each attribute value.

Once the voice characteristics of the reference voice sample 314 are weighted suitably, the voice generation engine 312 generate an output voice track, such as an output voice track 318, corresponding to an input text data based on the weighted voice characteristic information. For example, after assigning weight for each voice characteristics, then the voice generation model 214 of the system 302 uses the assigned weight to convert the input text data into corresponding output voice track 318. If in case, the comparison between attribute value and linked value fails, a new weight is assigned for the attribute values of the voice characteristics for future purpose. As would be understood, the generated output voice track 318, imitates the voice characteristics of the required user and produces a rightly dubbed output voice track for the input text data.

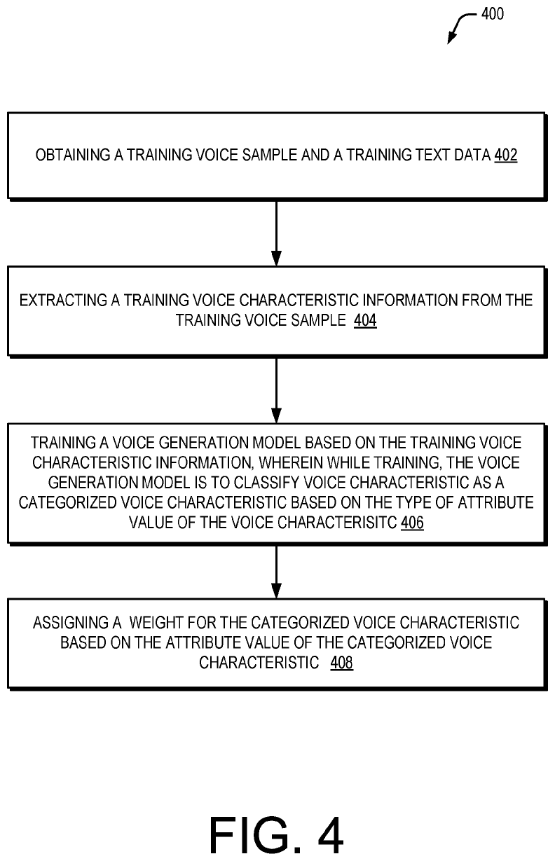

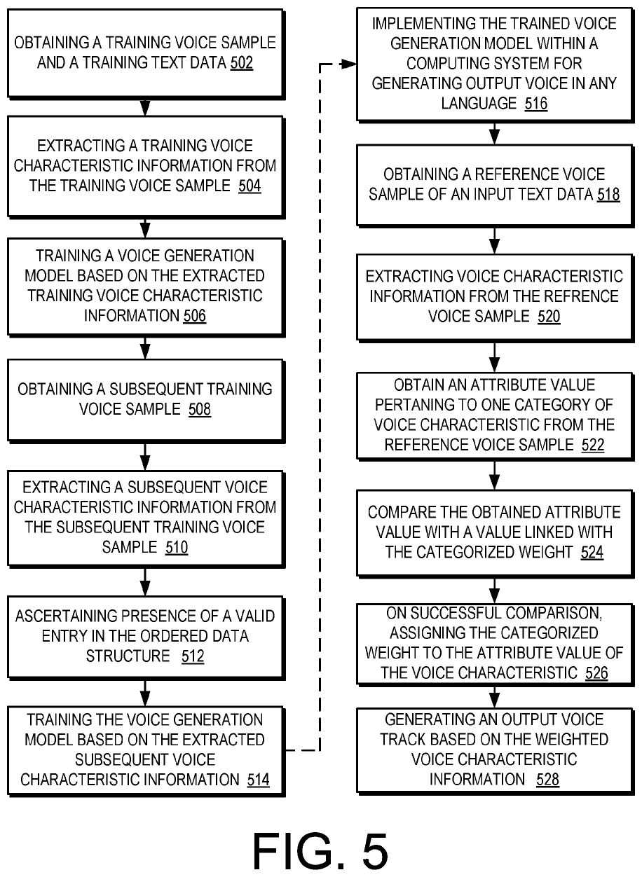

FIGS. 4-5 illustrate example methods 400-500 for training a voice generation model and generating voice output based on weight assigned to the voice characteristic information of a reference voice sample, in accordance with examples of the present subject matter. The order in which the above-mentioned methods are described is not intended to be construed as a limitation, and some of the described method blocks may be combined in a different order to implement the methods, or alternative methods.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the methods may be performed by a training system, such as system 202 and a voice generation system, such as system 302. In an implementation, the methods may be performed under an “as a service” delivery model, where the system 202 and the system 302, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 400 may be implemented by the system 202 for training the voice generation model 214 based on a training information, such as training information 208. At block 402, the training information 208 including a training voice sample, such as training voice sample 218 and a training text data, such as training text data 216, is obtained. For example, the system 202 may obtain the training information 208 from the repository 204 over the network 206. The system 202 may obtain the training information 208 in response to execution of instructions 210. In an example, the training information 208 may be used by the system 202 for extracting a training voice characteristic information, such as voice characteristic information 220 from it. In one example, one or more training voice sample 218 of different languages may be associated with single training text data 216.

At block 404, a training voice characteristic information is extracted from the training voice sample. For example, the training engine 212 may process the training voice sample 218 to extract the training voice characteristic information 220. In an example, the training engine 212 may obtain the training information 208 from the repository 204 over the network 206. In another example, the system 202 may include a repository, such as repository 204, which stores training information 208. Example of voice characteristics include, but may not be limited to, a type of phonemes present in the reference voice sample, number of phonemes, duration of each phoneme, pitch of each phoneme, and energy of each phoneme. As described previously, the training voice characteristic information 220 further includes training attribute values 222 corresponding to the voice characteristics of the training voice sample 218.

At block 406, a voice generation model 214 may be trained based on the training voice characteristic information 220. For example, on executing instructions 210, the training engine 212 trains the voice generation model 214 based on the attribute values, such as training attribute values 222 derived from the training voice characteristic information 220. In an example, the voice characteristic corresponding to the training attribute values 222 is classified as a categorized voice characteristic by analyzing type of the training attribute value of the voice characteristics. Similarly, other voice characteristics are also classified under different categories.

At block 408, a categorized weight is assigned for the categorized voice characteristic. For example, the training engine 212 assigns the categorized weight based on the training attribute value of the categorized voice characteristic to the categorized voice characteristic. In an example, categorized weight describes the operational intensity of the categorized voice characteristic to the voice generation model 214. In similar way, other voice characteristics of training voice sample 218 are linked with their respective weight based on the attribute value of the voice characteristics.

In an example, once trained, the voice generation model 214 may include a data structure, including plurality of entries grouped together based on type of language and type of voice characteristics. For example, an entry for each language contain respective entries of different categorized voice characteristics based on different attribute values associated with voice characteristics. Further, respective weights are also linked with each of the attribute value of the voice characteristics. In an example, the voice generation model 214 is subsequently trained based on subsequent training voice characteristic information comprising subsequent training attribute values corresponding to a subsequent training voice sample. The process of such subsequent training is further explained in conjunction with FIG. 5.

FIG. 5 illustrates another example method 500 for training a voice generation model based on which voice characteristics of a reference voice sample may be classified and weighted with their respective weights, and accordingly an output voice track is generated and outputted through a speaker. Based on the present approaches as described in the context of the example method 500, the voice characteristics of the reference voice sample 314 are classified as plurality of voice characteristics and associated with a weight, based on which the output voice track 318 corresponding to input text data is generated. It is pertinent to note that such training and eventual analysis of voice characteristic information may not occur in continuity and may be implemented separately without deviating from the scope of the present subject matter.

At block 502, a training information 208 including a training voice sample, such as training voice sample 218 and a training text data, such as training text data 216, is obtained. For example, the system 202 may obtain the training information 208 from the repository 204 over the network 206. The system 202 may obtain the training information 208 in response to execution of instructions 210. In an example, the training information 208 may be used by the system 202 for extracting a training voice characteristic information, such as voice characteristic information 220 from it. In one example, one or more training voice sample 218 of different languages may be associated with single training text data 216.

At block 504, a training voice characteristic information is extracted from the training voice sample. For example, the training engine 212 may process the training voice sample 218 to extract the training voice characteristic information 220. In an example, the training engine 212 may obtain the training information 208 from the repository 204 over the network 206. Example of voice characteristics include, but may not be limited to, a type of phonemes present in the reference voice sample, number of phonemes, duration of each phoneme, pitch of each phoneme, and energy of each phoneme. As described previously, the training voice characteristic information 220 further includes training attribute values 218 corresponding to the voice characteristics of the training voice sample 218.

At block 506, a voice generation model may be trained based on the training voice characteristic information. For example, on executing instructions 210, the training engine 212 trains the voice generation model 214 based on the attribute values, such as training attribute values 222 derived from the training voice characteristic information. In an example, the voice characteristics corresponding to the training attribute values 218 is classified as a categorized voice characteristic by analyzing type of the training attribute value of the voice characteristics and subsequently a categorized weight is assigned to the categorized voice characteristics. In an example, once trained, the voice generation model 214 includes an ordered data structure, which may include plurality of entries representing different languages and corresponding voice characteristics with different possible attribute values and their respective associated weights.

At block 508, a subsequent training information including a subsequent training voice sample and a subsequent training text data is obtained from the repository. For example, training engine 212 may obtain the subsequent training information, such as training information 208, from the repository 204 over the network 206. In an example, the system 202 may process the training information 208 to obtain the training voice characteristic information.

At block 510, a subsequent training voice characteristic information is extracted from the subsequent training voice sample. For example, the training engine 212 may process the derived training information 208 to extract the subsequent training voice characteristic information. In an example, the subsequent training voice characteristic information are further processed to derive the training attribute value.

At block 512, presence of a valid entry in the ordered data structure is ascertained. For example, the training engine 212 may process the derived training attribute values 218 on a trained voice generation model, such as voice generation model 214, including ordered data structure to ascertain presence of the valid entry, i.e., presence of entry corresponding to the training attribute value of the subsequent training voice characteristic information. If in case the valid entry is present, the training engine does not subsequently train the voice generation model. However, if in case the valid entry is not present, the training engine does train the voice generation model based on the subsequent training voice characteristic information.

At block 514, the voice generation model is trained using the subsequent training voice characteristic information. For example, the training engine 212, on determining that the valid entry is not present, creates an additional entry corresponding to the training attribute values of the subsequent training voice characteristic information and assign a new weight for these training attribute values of subsequent training voice characteristic information. In an example, the additional entry may be created under same voice characteristics but having different attribute value.

At block 516, the trained voice generation model is implemented within a computing system for analyzing voice characteristic information and generating output voice track of an input text data. For example, once the voice generation model 214 is trained, it may be utilized for analyzing voice characteristics of a reference voice sample, such as reference voice sample 314, to generate an output voice track, such as output voice track 318 for the inputted text data. Although block 516 is depicted as following block 514, the voice generation model 214 may be implemented separately without deviating from the scope of the present subject matter.

At block 518, a reference voice sample corresponding to an input text data is obtained. For example, the microphone(s) 308 of system 302 may receive the reference voice sample 314 from the user 306. Thereafter, the received reference voice sample 314 is obtained by system 302. In an example, the reference voice sample is further processed to extract a voice characteristic information, such as voice characteristic information 316 form it.

In another implementation, initially, a request from a user to convert an input text data, such as input text data into a specified language voice output is obtained. For example, the system 302 may receive only the input text data for converting it into corresponding output voice track. Thereafter, the system 302 may generate the output voice track 318 in the specified language based on a predefined voice characteristic information using a voice generation model, such as voice generation model 214. If in case user is not satisfied with the tonal and vocal characteristics of the output voice track 318, the user may provide a reference voice sample, such as reference voice sample 314 imitating certain part of the input text data to provide a reference voice characteristic information for the system to generate the output voice track. In one example, the reference voice sample 314 may be in a different language as compared to the input text data. For example, the reference voice sample is in Spanish and the input text data is in English. In such a case, the output voice track is generated in English based on the voice characteristics information of Spanish reference voice sample.

In another example, the user may also provide multiple reference voice sample for different portions of input text data for generating output voice track having different vocal characteristics at different duration based on the situation for which the text data is intended for.

At block 520, a voice characteristic information is extracted from the reference voice sample. For example, the voice generation engine 312 may process the reference voice sample 314 to extract the voice characteristic information 316. In an example, the voice generation engine 312 may obtain the reference voice sample 314 from the user 306 via microphone 308. Example of voice characteristics include, but may not be limited to, a type of phonemes present in the reference voice sample, number of phonemes, duration of each phoneme, pitch of each phoneme, and energy of each phoneme. As described previously, the voice characteristic information 316 further includes attribute values corresponding to the voice characteristics of the reference voice sample 314.

At block 522, attribute values pertaining to the voice characteristics are derived from the extracted voice characteristic information. For example, the voice generation engine 312 may derive the attribute values from the voice characteristic information 316. In an example, attribute values describe intensity level of vocal information pertaining to the voice characteristics of the reference voice sample 314.

At block 524, attribute values are compared with a value linked with the categorized voice characteristic. For example, the voice generation engine 312 may compare the derived attribute values of one category of the voice characteristics with the value linked with the categorized voice characteristics. In an example, the attribute values are numerical and alphanumerical values which may be compared with the numerical and alphanumerical identifiers associated with the categorized voice characteristics in the ordered data structure.

At block 526, categorized weight associated with values linked with categorized voice characteristic is assigned to attribute values of reference voice sample. For example, voice generation engine 312 may assign the categorized weight associated with values linked with categorized voice characteristics to the one of the attribute values of voice characteristic information 316 using voice generation model 214. In an example, once all the attribute values are assigned with corresponding weights, a weighted voice characteristic information is determined. If in case, one of the attribute values fails comparison, a new weight is assigned to the attribute value and this may be stored in the voice generation model for future voice generations.

At block 528, an output voice track is generated based on the weighted voice characteristic information. For example, the voice generation engine 312 may generate the output voice track 318 based on weighted voice characteristic information.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a microphone to receive a reference voice sample from a user;
a processor; and
a voice generation engine coupled to the processor, wherein the voice generation engine is to:
extract a voice characteristic information from the received reference voice sample;
process the voice characteristic information based on a voice generation model to assign a weight for each voice characteristics to generate a weighted voice characteristics information, wherein the voice generation model is trained based on a training voice characteristic information and a training text data; and
based on weighted voice characteristic information of the reference voice sample, generate an output voice track corresponding to an input text data.

2. The system as claimed in claim 1, wherein the voice characteristic information comprises attribute values corresponding to a plurality of voice characteristics of the reference voice sample based on which the input text data is to be converted into output voice track.

3. The system as claimed in claim 2, wherein the voice generation model comprises a categorized weight assigned to an attribute value of a categorized voice characteristic amongst the plurality of voice characteristics.

4. The system as claimed in claim 3, wherein the voice generation model is trained based on the training text data and a training voice sample, wherein the training text data and training voice sample is obtained from a sample data repository.

5. The system as claimed in claim 3, wherein to process the voice characteristic information, the voice generation engine is to:
derive the attribute value pertaining to one category of voice characteristic from the reference voice sample;
compare the derived attribute value with a value linked with the categorized weight assigned to the attribute value of categorized voice characteristic; and
on determining the derived attribute value to match with the value linked with the categorized weight, assign the categorized weight as the weight for the voice characteristic.

6. The system as claimed in claim 1, wherein the training voice characteristic information is extracted from the training voice sample and comprises attribute values corresponding to a plurality of voice characteristics.

7. The system as claimed in claim 6, wherein the plurality of voice characteristics comprises a type of phonemes present in the voice sample, number of phonemes, duration of each phoneme, pitch of each phoneme, and energy of each phoneme.

8. The system as claimed in claim 1, wherein the reference voice sample is a voice sample by using which user wanted to manipulate output voice track based on its voice characteristics.

9. A method comprising:
obtaining a training voice sample and a training text data;
extracting a training voice characteristic information from the training voice sample;
training a voice generation model based on the training voice characteristic information, wherein while training, the voice generation model is to classify voice characteristic as a categorized voice characteristic based on the type of an attribute value of the voice characteristic; and
assigning a weight for the categorized voice characteristic based on the attribute value of the categorized voice characteristic.

10. The method as claimed in claim 9, wherein the voice characteristics comprises a type of phonemes present in the voice sample, number of phonemes, duration of each phoneme, pitch of each phoneme, and energy of each phoneme.

11. The method as claimed in claim 9, wherein the training voice sample and training text data pertaining to different languages is obtained from a sample data repository.

12. The method as claimed in claim 9, further comprising:
obtaining a subsequent training voice sample;
extracting a subsequent training voice characteristic information from the subsequent training voice sample, wherein the subsequent training voice characteristic information comprises attribute values corresponding to voice characteristics of the subsequent training voice sample; and
training the voice generation model based on the extracted subsequent voice characteristic information.

13. The method as claimed in claim 12, wherein while training, on determining that the attribute values and the category of the subsequent voice characteristics does not correspond to any of the weight assigned, assigning a new weight and a new category for subsequent voice characteristic based on the attribute value of the subsequent voice characteristic.

14. The method as claimed in claim 9, wherein the training voice characteristic information comprises an attribute value corresponding to a plurality of voice characteristics.

15. The method as claimed in claim 14, wherein based on the attribute values, assigning corresponding weights to each voice characteristic amongst the plurality of voice characteristics.

16. A non-transitory computer-readable medium comprising computer-readable instructions, which when executed by a processor, causes a computing device to:
receive a request from a user to convert an input text data into an output voice track;
generate a predicted output voice track in a specified language based on a predefine voice characteristic information using a voice generation model;
if in case the predicted output voice track is inappropriate, receive a reference voice sample from the user;
extracting a voice characteristic information from the reference voice sample;
process the voice characteristic information to assign a weight to each voice characteristics using the voice generation model to generate a weighted voice characteristic information; and
based on the weighted voice characteristic information of the reference voice sample, generate an updated output voice track corresponding to the input text data.

17. The non-transitory computer-readable medium as claimed in claim 16, wherein the voice generation model is trained based on a training voice characteristic information and a training text data.

18. The non-transitory computer-readable medium as claimed in claim 17, wherein the training text data and training voice sample is obtained from a sample data repository.

19. The non-transitory computer-readable medium as claimed in claim 16, wherein the voice characteristic information comprises attribute values corresponding to a plurality of voice characteristics of the target voice sample based on which the input text data is to be converted into output voice track.

20. The non-transitory computer-readable medium as claimed in claim 19, wherein the plurality of voice characteristics comprises a type of phonemes present in the target voice sample, number of phonemes, duration of each phoneme, pitch of each phoneme, and energy of each phoneme.
